(19) United States
(12) Patent Application Publication
(10) Pub. No.: US 2016/0265359 A1
(43) Pub. Date: Sep. 15, 2016

(54) TURBOCHARGER WHEEL AND METHOD OF BALANCING THE SAME

(71) Applicant: CATERPILLAR INC., Peoria, IL (US)

(72) Inventors: Richard E. ANNATI, Lafayette, IN (US); Matthew J. Frick, Novi, MI (US); Douglas G. HOGGE, Hooper, UT (US)

(73) Assignee: CATERPILLAR INC., Peoria, IL (US)

(21) Appl. No.: 14/642,606

(22) Filed: Mar. 9, 2015

(51) Int. Cl. F01D 5/02; F01D 5/34; B23C 5/10; F04D 29/66; B23C 3/34; F04D 29/28; F02B 33/40

(52) U.S. Cl. CPC F01D 5/027; F04D 29/284; F01D 5/34; F02B 33/40; F04D 29/662; B23C 3/34; B23C 5/1009; F05D 2220/40; F05D 2230/10; F05D 2240/24; F05D 2240/20; F05D 2260/15

(57) ABSTRACT

A wheel of a turbocharger includes a first end opposite a second end and a rotational axis extending between the first end and the second end. The wheel also includes a back wall located at the second end and a balance groove formed in the back wall. The balance groove has a plurality of side walls and a bottom surface. The side walls and the bottom surface of the balance groove are milled surfaces.

### TECHNICAL FIELD

The present disclosure relates generally to a turbocharger, and more particularly, to a wheel of a turbocharger and a method of balancing the same.

### BACKGROUND

Internal combustion engines, for example, diesel engines, gasoline engines, or natural gas engines employ turbochargers to deliver compressed air for combustion in the engine. A turbocharger compresses air flowing into the engine, helping to force more air into the combustion chambers of the engine. The increased supply of air allows increased fuel combustion in the combustion chambers of the engine, resulting in increased power output from the engine.

A typical turbocharger includes a shaft, a turbine wheel attached to one end of the shaft, a compressor wheel or impeller connected to the other end of the shaft, and bearings to support the shaft. Often a turbine housing surrounds the turbine wheel and a separate compressor housing surrounds the compressor wheel.

When the engine is operating, hot exhaust from the engine flows through the turbine housing and expands over the turbine wheel, rotating the turbine wheel and the shaft connected to the turbine wheel. The shaft in turn rotates the compressor wheel. Relatively cool air from the ambient flows through the compressor housing where the compressor wheel compresses the air and drives the compressed air into the combustion chambers of the engine.

The compressor wheel and/or the turbine wheel may be unbalanced when its mass is distributed unevenly around its axis of rotation and the center of mass is out of alignment with the center of rotation. This may occur, for example, due to manufacturing tolerances. When unbalanced, the rotation of the compressor wheel and/or the turbine wheel may generate a centrifugal force that may produce undesirable noise and/or vibrations. The noise and/or vibrations may be excessive, and the vibrations may affect the performance of the turbocharger, e.g., by shortening its operating life, such as the life of the bearings.

One attempt to balance a turbine wheel is disclosed in U.S. Pat. No. 4,170,528 issued to Mathews on Oct. 9, 1979 (“the '528 patent”). In particular, the '528 patent discloses a method of balancing a turbine wheel using a grinding wheel that grinds off material from the turbine wheel. The grinding wheel is supplied with a flow of current, and an electrolyte solution is passed between the grinding wheel and a face of the turbine wheel. During grinding, current flows from the grinding wheel through the electrolyte solution to the turbine wheel, and anodic dissolution takes place, which removes material from the turbine wheel. Material is also removed from the turbine wheel through contact with abrasive particles on the grinding wheel.

Although the method of balancing the turbine wheel disclosed in the '528 patent attempts to remove material precisely and in a controlled manner that may be automated for mass production, the disclosed method of balancing the turbine wheel may still be less than optimal. In particular, by using a grinding wheel, the method of balancing the turbine wheel of the '528 patent may introduce microcracks and heat affected zones (e.g., zones affected by a concentration of high-temperature heat, such as the heat produced by grinding) in the turbine wheel, which may lead to fatigue failure and may reduce the life of the turbine wheel. Also, the grinding wheel may produce sharp corners that may act as stress risers (e.g., locations where stress is concentrated), which may also lead to failure and may reduce the life of the turbine wheel.

The turbocharger wheel and method of balancing the turbocharger wheel of the present disclosure solves one or more of the problems set forth above and/or other problems of the prior art.

### SUMMARY

In one aspect, the present disclosure is directed to a wheel of a turbocharger. The wheel includes a first end opposite a second end and a rotational axis extending between the first end and the second end. The wheel also includes a back wall located at the second end and a balance groove formed in the back wall. The balance groove has a plurality of side walls and a bottom surface. The side walls and the bottom surface of the balance groove are milled surfaces.

In another aspect, the present disclosure is directed to a wheel of a turbocharger including a first end opposite a second end and a rotational axis extending between the first end and the second end. The wheel also includes a back wall located at the second end and a balance groove formed in the back wall. The balance groove has a plurality of side walls and a bottom surface. The side walls include first and second side walls that each extend in a radial direction with respect to the rotational axis of the wheel. Each of the first and second side walls curve inward toward the bottom surface of the balance groove. The side walls also include third and fourth side walls that each extend in a circumferential direction with respect to the rotational axis of the wheel. Each of the third and fourth side walls curve inward toward the bottom surface of the balance groove. The wheel is formed integrally as a single-piece component. The side walls and the bottom surface of the balance groove are milled surfaces. Each pair of adjacent side walls intersect to form a curved surface.

In another aspect, the present disclosure is directed to a method of balancing a wheel of a turbocharger. The wheel includes a first end opposite a second end and a rotational axis extending between the first end and the second end. The wheel further includes a back wall located at the second end. The method includes forming a balance groove in the back wall by removing material from the back wall using a milling tool. Forming the balance groove includes forming a plurality of side walls of the balance groove using the milling tool.

### BRIEF DESCRIPTION OF THE DRAWINGS

FIG. 1 is a cross-sectional view of a turbocharger, according to an exemplary embodiment;

FIG. 2 is a rear view of a wheel of the turbocharger of FIG. 1;

FIG. 3 is a cross-sectional view of the wheel taken along the line A-A of FIG. 2;

FIG. 4 is an enlarged rear view of a balance groove of the wheel of FIG. 2; and

FIG. 5 is a flow chart illustrating a method of balancing one or more wheels of a turbocharger, according to an exemplary embodiment.

### DETAILED DESCRIPTION

Reference will now be made in detail to exemplary embodiments, which are illustrated in the accompanying drawings. Wherever possible, the same reference numbers will be used throughout the drawings to refer to the same or like parts.

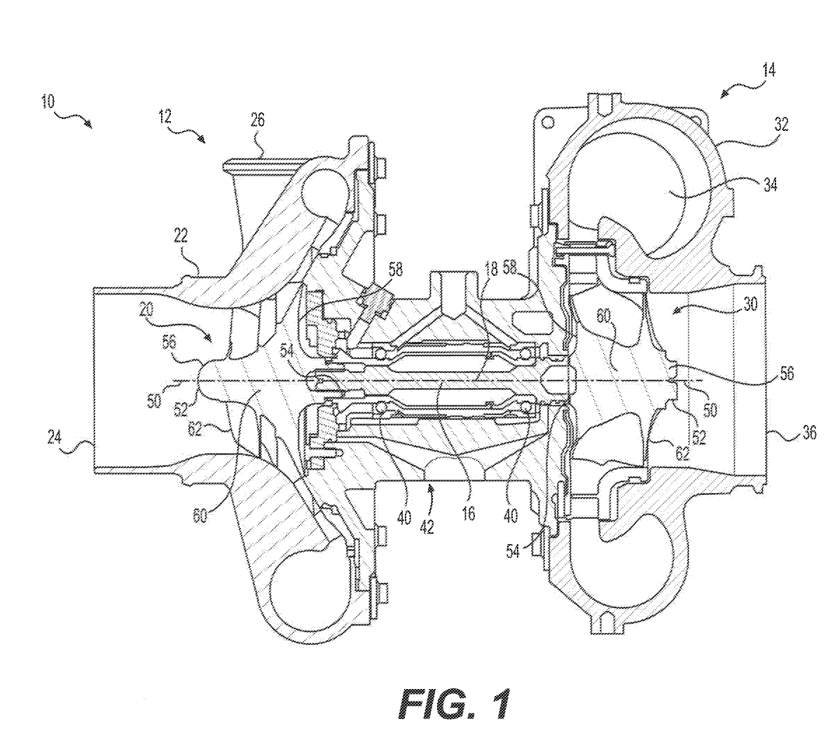

FIG. 1 illustrates an exemplary embodiment of a turbocharger 10. The turbocharger 10 may be used with an engine (not shown) of a machine that performs some type of operation associated with an industry such as railroad, marine, power generation, mining, construction, farming, or another industry known in the art. As shown in FIG. 1, the turbocharger 10 may include a compressor stage 12 and a turbine stage 14 connected by a shaft 16.

The compressor stage 12 may embody a fixed geometry compressor impeller or wheel 20 disposed in a compressor housing 22. The compressor wheel 20 and the compressor housing 22 may be disposed around a rotational axis 18 of the shaft 16. The compressor wheel 20 may be attached to the shaft 16 and configured to compress air received at an ambient pressure level before the air enters the engine for combustion. Air may enter the compressor housing 22 via a compressor inlet 24 and exit the compressor housing 22 via a compressor outlet 26. As air moves through the compressor stage 12, the compressor wheel 20 may force compressed air into the engine.

The turbine stage 14 may include a turbine wheel 30, which may be attached to the shaft 16 and may be disposed in a turbine housing 32. The shaft 16 may extend from the compressor housing 22 to the turbine housing 32. The turbine wheel 30 and the turbine housing 32 may be disposed around the rotational axis 18 of the shaft 16. Exhaust gases exiting the engine may enter the turbine housing 32 via a turbine inlet 34 and exit the turbine housing 32 via a turbine outlet 36. As the hot exhaust gases move through the turbine housing 32 and expand against blades 62 (described below) of the turbine wheel 30, the turbine wheel 30 may rotate the compressor wheel 20 via the shaft 16.

Bearings 40 may support the shaft 16. The bearings 40 may be disposed in a bearing housing 42. Although FIG. 1 illustrates only two bearings 40, it is contemplated that the turbocharger 10 may include any number of bearings 40.

The compressor wheel 20 and the turbine wheel 30 may include similar features. For example, each of the compressor wheel 20 and the turbine wheel 30 may rotate about a rotational axis 50, which may be collinear with the rotational axis 18 of the shaft 16. Each of the compressor wheel 20 and the turbine wheel 30 may include a first end 52, a second end 54 located opposite the first end 52, and the rotational axis 50 may extend between the first end 52 and the second end 54. Opposite ends of the shaft 16 may attach to the respective second ends 54 of the compressor wheel 20 and the turbine wheel 30. Each of the compressor wheel 20 and the turbine wheel 30 may include a nose 56 located at the respective first end 52, a back wall 58 located at the respective second end 54, a hub 60 extending along the rotational axis 50 between the nose 56 and the back wall 58, and a plurality of blades 62 disposed around the hub 60. Although the compressor wheel 20 and the turbine wheel 30 may include these similar features, these features may differ in number, size, shape, and/or other configuration. For example, the compressor wheel 20 and the turbine wheel 30 may have a different number of blades 62 with different shapes and/or sizes. Also, the compressor wheel 20 and the turbine wheel 30 may have noses 56, back walls 58, and hubs 60 of different shapes and sizes.

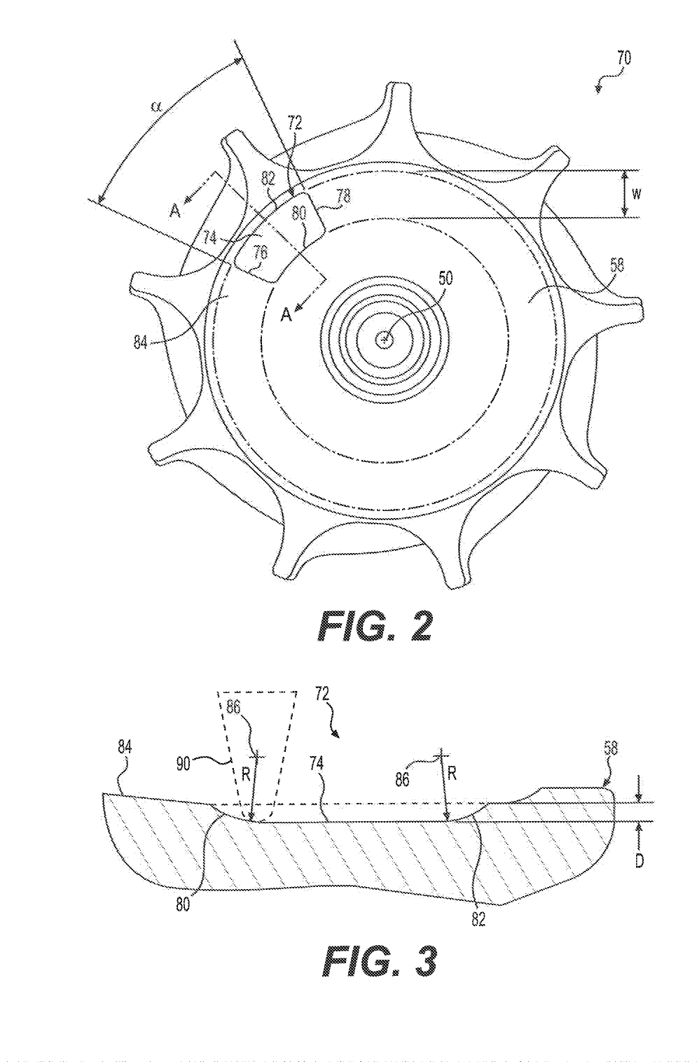

Each of the compressor wheel 20 and the turbine wheel 30 shown in FIG. 1 may be balanced. FIGS. 2-4 illustrate a balanced wheel 70, which may be the compressor wheel 20 and/or the turbine wheel 30 shown in FIG. 1. The wheel 70 may include the rotational axis 50, the first end 52, the second end 54, the nose 56, the back wall 58, the hub 60, and/or the blades 62 described above. The wheel 70 shown in FIG. 2 includes nine blades, but it is understood that the wheel 70 may include more or fewer than nine blades 62. The wheel 70 may be formed integrally as a single-piece cast metal component. For example, the wheel 70 may be formed of titanium (e.g., titanium alloy, such as Ti 6-4), nickel, and/or other metal or metal alloy.

The wheel 70 may include a balance groove 72 formed in the back wall 58. The balance groove 72 may include a bottom surface 74 and a plurality of side walls. For example, the side walls may include a first side wall 76, a second side wall 78, a third side wall 80, and a fourth side wall 82. The first side wall 76 and the second side wall 78 may each extend in a radial direction (along the direction of a radius of the wheel 70) with respect to the rotational axis 50 of the wheel 70. The first side wall 76 and the second side wall 78 may be separated by an angle α of about 20° to about 180°, e.g., about 20° to about 30°.

The third side wall 80 and the fourth side wall 82 may each extend in a circumferential direction (along the direction of rotation of the wheel 70) with respect to the rotational axis 50 of the wheel 70. The third side wall 80 and the fourth side wall 82 may extend between the first side wall 76 and the second side wall 78. The third side wall 80 may be located a first distance from the rotational axis 50 of the wheel 70, the fourth side wall 82 may be located a second distance from the rotational axis 50, and the second distance may be greater than the first distance. In an embodiment, the third side wall 80 may be located about 41 mm or more from the rotational axis 50 of the wheel 70, the fourth side wall 82 may be located about 57 mm or less from the rotational axis 50 of the wheel 70, and the third side wall 80 and the fourth side wall 82 may be separated by a width W of about 16 mm or less.

The balance groove 72 may be formed in a portion of the back wall 58 having a continuous curved or flat surface. The back wall 58 may extend generally in a radial direction with respect to the rotational axis 50 of the wheel 70. Prior to the formation of the balance groove 72, the back wall 58 may be flat, curved, or conical. For example, the back wall 58 of the compressor wheel 20 and the turbine wheel 30 may curve inward and may be substantially concave, as shown in FIG. 1.

In an embodiment, the balance groove 72 maybe located in an outer ring of the back wall 58 defined by an outer half of a radius of the back wall 58. For example, if the radius of the back wall 58 is about 60 mm, then the outer ring of the back wall 58 may be defined by the portion of the back wall 58 that is 30 mm (half of the radius of the back wall 58) or more from the rotational axis 50 of the wheel 70. In an embodiment, the balance groove 72 may be located entirely or at least partially within the outer ring of the back wall 58.

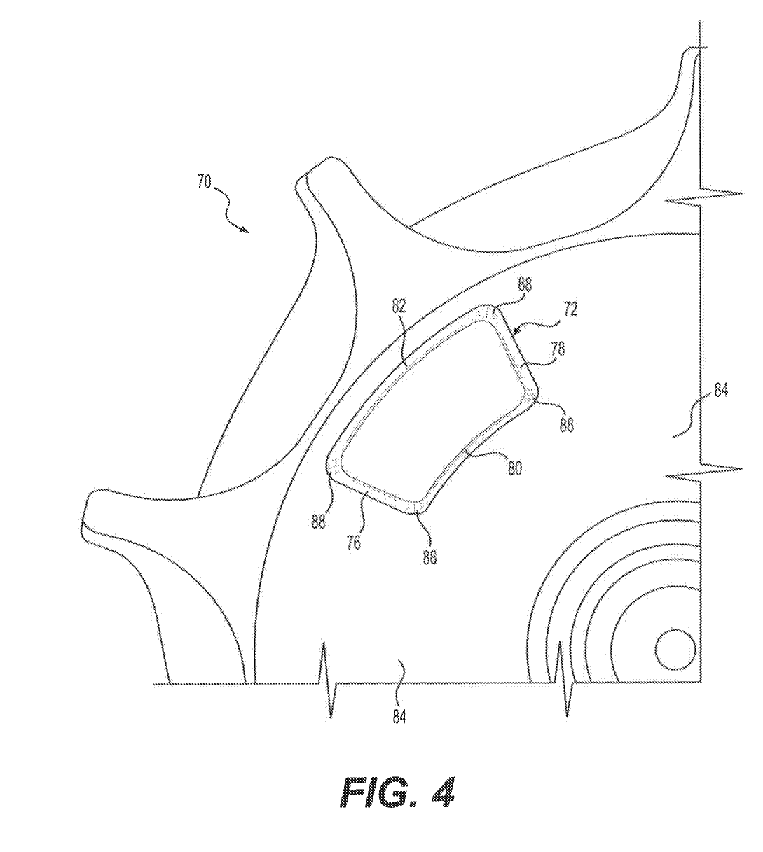

Each of the first side wall 76, the second side wall 78, the third side wall 80, and the fourth side wall 82 may connect a rear-facing surface 84 of the back wall 58 to the bottom surface 74 of the balance groove 72. Each of the side walls 76, 78, 80, and 82 may have a smooth (e.g., without angled corners) and continuous curvature between the rear-facing surface 84 of the back wall 58 and the bottom surface 74. As shown in FIGS. 3 and 4, each of the side walls 76, 78, 80, and 82 may curve inward toward the bottom surface 74 of the balance groove 72. As shown in FIG. 3, each of the third side wall 80 and the fourth side wall 82 may have a radius of curvature R with respect to a respective axis 86 that extends in the circumferential direction. The radius of curvature R may be generally constant along the length of the respective third side wall 80 and the fourth side wall 82 along the circumferential direction.

Each of the first side wall 76 and the second side wall 78 may have a similar radius of curvature. The radius of curvature for each of the first side wall 76 and the second side wall 78 may be generally constant along the length of the respective first side wall 76 and the second side wall 78 along the radial direction. The radius of curvature for each of the first side wall 76 and the second side wall 78 may be generally equal to the radius of curvature R of the third side wall 80 and the fourth side wall 82 described above.

The balance groove 72 may be formed so that intersections of the side walls 76, 78, 80, and 82 and the bottom surface 74 are formed without angled corners. Also, as shown in FIG. 4, each pair of adjacent side walls 76, 78, 80, and 82 may intersect to form a curved surface 88 without an angled corner. Each curved surface 88 may also extend towards the bottom surface 74 and may have a radius of curvature that is generally equal to the radius of curvature R of the side walls 76, 78, 80, and 82 described above.

The balance groove 72 may be formed by milling. In an embodiment shown in FIG. 3, the balance groove 72 may be formed using a milling tool 90, such as a ball end mill. The milling tool 90 may also have a radius of curvature that is equal to the radius of curvature R of the side walls 76, 78, 80, and 82, as described above. Thus, each of the milling tool 90 and the side walls 76, 78, 80, and 82 may have the same radius of curvature R. For example, the milling tool 90 may be a tapered ball end mill having a radius of curvature of about 5 mm, and the radius of curvature R of the side walls 76, 78, 80, and 82 may be equal to about 5 mm. Alternatively, the milling tool 90 may have a radius of curvature of less than about 5 mm, and the radius of curvature R of the side walls 76, 78, 80, and 82 may be less than about 5 mm. The milled surfaces may have a surface finish with a cusp height of about 0.02 mm or less.

The balance groove 72 may have a depth D of about 1 mm or less. The depth D may be a distance between the rear-facing surface 84 of the back wall 58 and the bottom surface 74 of the balance groove 72. In an embodiment, the depth D may be less than the radius of curvature R of the side walls 76, 78, 80, and 82 described above so that the radius of curvature R is relatively gentle (large).

As described above and shown in FIGS. 3 and 4, each of the side walls 76, 78, 80, and 82 may have a smooth (e.g., without angled corners) and continuous curvature between the rear-facing surface 84 of the back wall 58 and the bottom surface 74. Alternatively, one or more of the side walls 76, 78, 80, and 82 may include a straight portion or may be entirely straight, and may form an angled corner or a corner having a radius of curvature (e.g., the radius of curvature R) at the intersection with the bottom surface 74.

### INDUSTRIAL APPLICABILITY

The disclosed turbocharger wheel and method of balancing the turbocharger wheel find potential application in relation to any turbocharger. The disclosed turbocharger wheel and method of balancing the turbocharger wheel find particular applicability in relation to a turbocharger associated with an internal combustion engine. One skilled in the art will recognize, however, that the disclosed turbocharger wheel and method of balancing the turbocharger wheel could be utilized in relation to other systems that may or may not be associated with a turbocharger associated with an internal combustion engine.

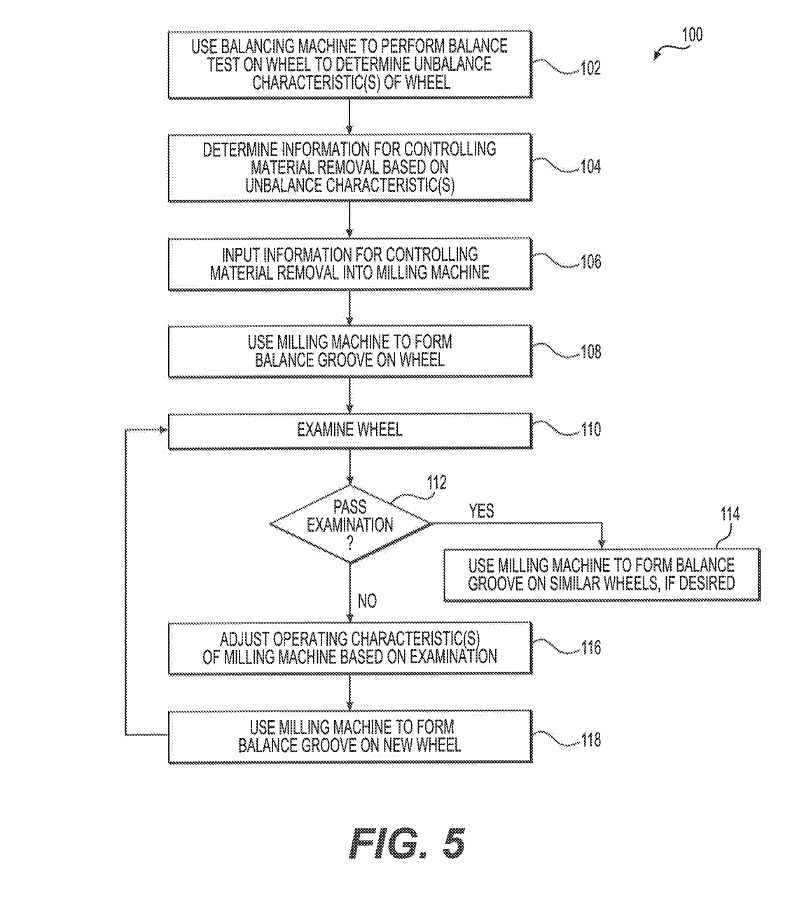

FIG. 5 is a flow chart illustrating a method 100 of balancing one or more wheels 70, according to an exemplary embodiment. Before forming the balance groove 72 in the back wall 58, an operator may use a balancing machine (not shown) to perform a balance test on the wheel 70 (step 102). The balance test may be performed to determine at least one unbalance characteristic of the wheel 70. The unbalance characteristic(s) may be used to characterize the distribution of mass in the wheel 70 around its axis of rotation. For example, the unbalance characteristic(s) may include a magnitude and a direction of an unbalanced force in the wheel 70 when it rotates. The balancing machine may perform the balance test on the wheel and may determine the unbalance characteristic(s).

The operator and/or the balancing machine may determine information for controlling material removal based on the unbalance characteristic(s) determined by the balancing machine (step 104). In an embodiment, the balancing machine may use the unbalance characteristic(s) to determine information for controlling material removal to balance the wheel 70. For example, the information for controlling material removal may include at least one characteristic of the balance groove 72, e.g., a location of the balance groove 72 in the back wall 58, a size (e.g., angle α, width W, depth D, radius of curvature R, etc.) of the balance groove 72, etc. The balancing machine may output the information for controlling material removal. Alternatively, the operator or the milling machine (rather than the balancing machine) may determine the information for controlling material removal based on unbalance characteristic(s), which may be output from the balancing machine.

The operator and/or the balancing machine may input the information for controlling material removal into a milling machine (step 106). For example, the milling machine may include the milling tool 90. The operator may use the milling machine to form the balance groove 72 on the wheel 70 (step 108). In an embodiment, the information for controlling material removal may be input into the milling machine, and, based on the inputted information, the milling machine may automatically form the balance groove 72 on the wheel 70. For example, the milling machine may automatically control one or more operating characteristics, such as the cutting speed, e.g., the speed of rotation of the milling tool 90, and/or feed rate, e.g., the speed at which the milling tool 90 advances along the back wall 58 of the wheel 70. The cutting speed and/or feed rate may be controlled by the milling machine based on the inputted information for controlling material removal and may also be determined so that the formation of stress risers, microcracks, surface imperfections, and/or other features that may reduce the life of the wheel 70 may be reduced.

After forming the balance groove 72 on the wheel 70, the operator may examine the wheel 70 (step 110). For example, the operator may examine the wheel 70 for stress risers, microcracks, surface imperfections, or other features that may reduce the life of the wheel 70. Alternatively, or in addition, the operator may use the balancing machine to perform the balance test on the wheel 70. If the operator determines that the wheel 70 passes examination (step 112; yes), then the operator may use the milling machine to form the balance groove 72 on similar wheels 70, if desired (step 114). For example, the operator may repeat step 108 to form the balance groove 72 on other wheels 70 that are formed of the same material and/or manufactured using the same dimensions and tolerances as the wheel 70 examined in step 110. The balance groove 72 on the other wheels 70 may be formed using the same information for controlling material removal determined using step 104, and therefore steps 102-106 may be omitted for the other wheels 70.

On the other hand, if the operator determines that the wheel 70 does not pass examination (step 112; no), then the operator may adjust the operating characteristic(s) of the milling machine based on the examination (step 116). For example, if the operator determines that the amount of stress risers, microcracks, surface imperfections, and/or other features in the wheel 70 that may reduce the life of the wheel 70 is unacceptable, then the operator may adjust the cutting speed or feed rate of the milling machine. If the operator uses the balancing machine to perform the balance test on the wheel 70 in step 110, and the unbalanced force in the wheel 70 determined from the balance test is unacceptable (e.g., too large in magnitude), then the operator may use the results and adjust the information for controlling material removal, e.g., the characteristic(s) of the balance groove 72.

The operator may then use the milling machine on a new wheel 70 (e.g., formed of the same material and/or manufactured using the same dimensions and tolerances as the wheel 70 examined in step 110) to form the balance groove 72 on the new wheel 70 (step 118). The operator may then return to steps 110 and 112 to examine the wheel 70 and to determine if the wheel 70 passes examination.

The flow chart described above in connection with FIG. 5 depicts an exemplary embodiment of the method of balancing one or more turbocharger wheels. Those skilled in the art will recognize that similar methods may be used without deviating from the scope of the present disclosure.

Several advantages over the prior art may be associated with the turbocharger wheel and method of balancing the turbocharger wheel described above. Because the balance groove 72 in the wheel 70 is formed using a milling tool (rather than, for example, using a grinding wheel), the wheel 70 may be formed with fewer stress risers, microcracks, surface imperfections, and/or other features that may reduce the life of the wheel 70. Also, the balance groove 72 may be formed in the outer ring of the wheel 70 where there may be fewer or no heat affected zones. Forming the balance groove 72 in a heat affected zone may lead to fatigue failure and may reduce the life of the wheel 70. In addition, the wheel 70 may be formed with relatively gentle (large) radii, for example, at the base of the balance groove 72 where the side walls 76, 78, 80, and 82 meet the bottom surface 74 of the balance groove 72. As a result, stresses in the wheel 70 may be minimized.

The balance groove 72 may be formed in the back wall 58, which may be a continuous curved or flat surface. As a result, there may be no need to provide a sacrificial ring on the back wall 58 or other material that protrudes rearward from the back wall 58 and that may be at least partially removed to balance the wheel 70. Alternatively, the wheel 70 may include a sacrificial ring on the back wall 58, and the balance groove 72 may be formed in the sacrificial ring. The sacrificial ring may extend, e.g., 360 degrees, around the rotational axis 50 on the back wall 58, and the balance groove 72 may be formed in the sacrificial ring to remove part of material from the sacrificial ring to balance the wheel 70.

The method of balancing the wheel 70 may include using the milling machine to automatically control the removal of material to form the balance groove 72. For example, the milling machine may automatically control one or more operating characteristics, such as the cutting speed and/or feed rate. As a result, the cutting operation may be automated and controlled to reduce damage to the wheel 70 and reduce variability between wheels 70. Also, the operating characteristic(s) of the milling machine may be optimized to reduce the formation of stress risers, microcracks, surface imperfections, and/or other features that may reduce the life of the wheel 70.

It will be apparent to those skilled in the art that various modifications and variations can be made to the disclosed turbocharger wheel and method of balancing the turbocharger wheel. Other embodiments will be apparent to those skilled in the art from consideration of the specification and practice of the disclosed turbocharger wheel and method of balancing the turbocharger wheel. It is intended that the specification and examples be considered as exemplary only, with a true scope being indicated by the following claims and their equivalents.

What is claimed is:

1. A wheel of a turbocharger, the wheel comprising:
a first end opposite a second end;
a rotational axis extending between the first end and the second end;
a back wall located at the second end; and
a balance groove formed in the back wall, the balance groove having a plurality of side walls and a bottom surface;
wherein the side walls and the bottom surface of the balance groove are milled surfaces.

2. The wheel of claim 1, wherein the plurality of side walls include:
first and second side walls that each extend in a radial direction with respect to the rotational axis of the wheel; and
third and fourth side walls that each extend in a circumferential direction with respect to the rotational axis of the wheel.

3. The wheel of claim 2, wherein:
each of the plurality of side walls curve inward toward the bottom surface of the balance groove; and
each of the first, second, third, and fourth side walls has a smooth curvature and connects a surface of the back wall to the bottom surface of the balance groove.

4. The wheel of claim 2, wherein the first and second side walls are separated by an angle of about 20° to about 30°.

5. The wheel of claim 2, wherein the third and fourth side walls are separated by about 16 mm or less, the third side wall is located a first distance from the rotational axis of the wheel, and the fourth side wall is located a second distance from the rotational axis, the second distance being greater than the first distance.

6. The wheel of claim 1, wherein each of the milled surfaces has a surface finish with a cusp height of about 0.02 mm or less.

7. The wheel of claim 1, wherein the balance groove has a depth that is less than a radius of curvature of each of the side walls.

8. The wheel of claim 1, wherein the balance groove has a depth of about 1 mm or less, the depth being a distance between a surface of the back wall and a surface of the balance groove; and each of the side walls has a radius of curvature of about 5 mm or less.

9. The wheel of claim 1, wherein the balance groove is located in an outer ring of the back wall defined by an outer half of a radius of the back wall.

10. The wheel of claim 1, wherein:
the wheel is formed integrally as a single-piece component, and is a compressor wheel or a turbine wheel; and
the wheel further includes:
a hub extending along the rotational axis of the wheel between a nose located at the first end and the back wall located at the second end; and
a plurality of blades extending from the hub.

11. A wheel of a turbocharger, the wheel comprising:
a first end opposite a second end;
a rotational axis extending between the first end and the second end;
a back wall located at the second end; and
a balance groove formed in the back wall, the balance groove having a plurality of side walls and a bottom surface, the side walls including:
first and second side walls that each extend in a radial direction with respect to the rotational axis of the wheel, each of the first and second side walls curving inward toward the bottom surface of the balance groove, and
third and fourth side walls that each extend in a circumferential direction with respect to the rotational axis of the wheel, each of the third and fourth side walls curving inward toward the bottom surface of the balance groove;
wherein the wheel is formed integrally as a single-piece component, the side walls and the bottom surface of the balance groove are milled surfaces, and each pair of adjacent side walls intersect to form a curved surface.

12. The wheel of claim 11, wherein the intersections of the side walls and the bottom surface are formed without angled corners.

13. A method of balancing a wheel of a turbocharger, the wheel including a first end opposite a second end and a rotational axis extending between the first end and the second end, the wheel further including a back wall located at the second end, the method comprising:
forming a balance groove in the back wall by removing material from the back wall using a milling tool, forming the balance groove including forming a plurality of side walls of the balance groove using the milling tool.

14. The method of claim 13, wherein forming the plurality of side walls using the milling tool includes:
forming first and second side walls of the plurality of side walls using the milling tool, each of the first and second side walls extending in a radial direction with respect to the rotational axis of the wheel, each of the first and second side walls being straight or curving inward toward a bottom surface of the balance groove; and
forming third and fourth side walls of the plurality of side walls using the milling tool, each of the third and fourth side walls extending in a circumferential direction with respect to the rotational axis of the wheel, each of the third and fourth side walls being straight or curving inward toward the bottom surface of the balance groove.

15. The method of claim 13, further including:
using a milling machine including the milling tool to form the balance groove; and
before removing the material to form the balance groove, inputting information for controlling the material removal into the milling machine.

16. The method of claim 15, wherein:
the information for controlling the material removal includes at least one of a location or a size of the balance groove; and
the milling machine automatically controls at least one of a cutting speed or a feed rate for forming the balance groove based on the information for controlling the material removal.

17. The method of claim 15, further including:
before removing the material to form the balance groove, using a balancing machine to perform a balance test on the wheel; and
determining the information for controlling the material removal based on the balance test.

18. The method of claim 17, further including:
determining at least one unbalance characteristic of the wheel using the balancing machine; and
determining the information for controlling the material removal based on the at least one unbalance characteristic using the balancing machine.

19. The method of claim 18, wherein the at least one unbalance characteristic includes a magnitude and a direction of an unbalanced force in the wheel.

20. The method of claim 13, wherein the milling tool includes a ball end mill.
